(19) United States
(12) Patent Application Publication
(10) Pub. No.: US 2011/0155417 A1
(43) Pub. Date: Jun. 30, 2011

(54) CONDUCTING WIRE STRUCTURE AND METHOD OF MANUFACTURING A CONDUCTING WIRE CORE

(76) Inventor: Jen-Yao HU, Tainan County (TW)

(21) Appl. No.: 12/651,205

(22) Filed: Dec. 31, 2009

(51) Int. Cl. H01B 7/08; H01B 13/00; H01B 13/016

(52) U.S. Cl. 174/116; 174/113 R; 156/50

(57) ABSTRACT

A conducting wire structure and a method of manufacturing a conducting wire core, the conducting wire comprises at least one core and an insulation skin encasing the core. The core is formed by stacking a plurality of flattened conductors with flattened cross sections interposed by an insulation layer. The insulation layer bonds two neighboring flattened conductors to form the core in an integrated manner. The flattened conductors can conduct an identical electric signal. Thus the surface area of the flattened conductors can transmit electric power or signal to maximize conductive area of one core. The method of manufacturing a core includes: providing a plurality of flattened conductors with flattened cross sections through a conductor flattened fabrication means; coating an insulation layer on the surface of the flattened conductors through a coating means; and stacking the flattened conductors coaxially to form a core. Thus conductive surface area can be maximized.

### FIELD OF THE INVENTION

The present invention relates to a conducting wire structure and a method of manufacturing a conducting wire core and particularly to a conducting wire containing a special conductor structure.

### BACKGROUND OF THE INVENTION

Ever since human being started using electric power, how to transmit the electric power is a subject constantly pursued by mankind. In the early development stage of electrical science, Ohm's law was discovered. Ohm's law can be summed up in an equation: V=IxR, where V represents voltage, R represents resistance, and I represents current passing through the resistance R when the voltage V is applied thereon. Theoretically, whether electric power can pass through an object depends on the resistance of the object. According to Ohm's law, current I flows through a path of the lowest resistance. Hence applying a voltage on an object, current tends to flow through the portion where the resistance is the lowest. In order to reduce electricity loss during transmission, aside from selecting a conductor with a smaller resistance, other phenomena of electric power transmission on the conductor also have to be taken into account. One of such phenomena is “skin effect”. It is not intended here to discuss the mathematic formula of the “skin effect”. In short, “skin effect” is a physical phenomenon in which resistance of a conductor increases with increasing of AC frequency. More specifically, as AC frequency increases, the resistance of a conductor also increases such that current tends to flow on the outer circumference or surface of a conductor (referring to FIG. 1). Hence given AC of the same frequency, the greater surface area of a conductor a greater amount current can pass through the conducting wire. Under such a phenomenon, if the conducting wire still adopts the conventional round cross-section one, electric power merely passes through the surface of the conducting wire and a great portion of the metallic conductors in the center is useless and becomes a waste of resource.

Concerning the “skin effect”, the conductor of the conducting wire ought to have its shape or arrangement changed in a desired manner to allow maximum current to pass through and reduce loss and improve utilization of resources. One of practices is to maximize the surface area of the conductor and shrink the cross section thereof where current does not flow through. More specifically, a conventional approach is changing a single conductor to a plurality of conductors bundled together to become a stranded wire. Then the surface area of one conductor can be enlarged to the surface area of multiple conductors. For instance, R.O.C. patent No. M319508 entitled “Improved cable structure” includes two or more conductors wound to form a conducting wire. Such a structure can increase the surface area of the conductor allowing high frequency current to pass through and also shrink the cross section at the center of the conductor. Its manufacturing method is relatively simple, and the stranded wire can be used on most duty voltage or frequency of conducting wire, thus is widely adopted. Various alterations have been developed based on the aforesaid technique of the stranded wire. For instance, R.O.C. patent No. M339783 entitled “Improved wire structure for concentrator photovoltaic modules” discloses another type of single-core or multi-core conducting wire in which one or more core is bundled together to once encase a white Teflon wire. Another R.O.C. patent No. M347650 entitled “XLPE hyper voltage power cable structure for 400 KV” is applicable for high voltage power cable. It is formed by bundling a great deal of copper cores. Other references also are available in R.O.C. patent pub. Nos. 394289 entitled “Improved conducting wire structure”, 405746 entitled “Differential pair cable”, and M340532 entitled “Energy saving electric cord and cable”.

Most of the conventional techniques set forth above adopt stranded wire to increase current flowing amount. There is another approach by trying to increase the surface area of a single conductor, such as R.O.C. patent No. I270087 entitled “Core of electric power or signal transmission wire”. It discloses a wire containing a core. The core has an equilateral geometric section adjacent to a scalene geometric section. The scalene geometric section has an extended section directed inwards to form a surface area greater than the equilateral geometric section, thus can be used for power or signal transmission. While it provides a breakthrough over the conventional technique of round conductor wire and offers enhanced electric conduction capability, fabricating the scalene geometric section involves more complex processes than manufacturing the round conductor. Moreover, different types of scalene geometric section have varying physical strengths and their capability to withstand external forces such as compression or bending also are different, and might even be inferior to the round conductor. Taking into account of fabrication cost, speed and physical strength of the conductor body, its application is limited.

Although the stranded wire provides a wider application scope, it still leaves a lot to be desired, especially at present when almost countries around the world pursue “Green power” or “Green energy”, and various energy-saving regulations are being proposed or established, to improve transmission efficiency of high power conducting wire to avoid energy loss on power conducting wire of electric appliances. However, changing the form of the conducting wire incurs additional manufacturing difficulties and higher cost. All these show that there are still rooms for improvement.

### SUMMARY OF THE INVENTION

In view of the aforesaid problems occurred to the conventional conducting wire, the primary object of the present invention is to provide a conducting wire structure and method of manufacturing an inner core of the conducting wire that offers the core can enlarge surface area of a conductor to facilitate high frequency current passing thereby to enlarge current flowing path and increase current conducting amount.

The conducting wire structure according to the present invention includes at least one core and an insulation skin encasing outer edge of the core to form a conducting wire. The core contains a plurality of flattened conductors formed in a flattened cross section and stacked together. The flattened conductors are interposed by an insulation layer which bonds two neighboring flattened conductors, and then the bonded conductors are stacked to form the core in an integrated manner. The flattened conductors in the core can conduct an identical electric signal, hence the combined surface area of the flattened conductors can also transmit electric power or signals to maximize the conductive area of a single core. The present invention also provides a method to fabricate the core. The method includes procedures as follow: providing a plurality of flattened conductors with flattened cross sections through a flattened conductor fabrication means; coating an insulation layer on the surfaces of the flattened conductors through a coating means; stacking the flattened conductors coaxially to form a core. The flattened conductor fabrication means can form the flattened conductors from calendering conductors with any shapes or cutting a flattened conductor. By means of the present invention, the flattened conductors can be stacked to get maximum conductive surface area and fabricated at a lower cost and faster speed to produce a conducting wire of a higher electric conductivity.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the present invention.

FIG. 2A is a sectional view according to FIG. 1.

FIG. 2B is a fragmentary enlarged view according to FIG. 2A.

FIG. 3 is a sectional view of another embodiment of the conducting wire structure of the present invention.

FIG. 4 is a sectional view of yet another embodiment of the conducting wire structure of the present invention.

FIG. 5 is a sectional view of still another embodiment of the conducting wire structure of the present invention.

FIG. 6 is a flowchart for fabricating the core of the present invention.

FIG. 7 is an implementation flowchart of the flattened conductor fabrication means.

FIG. 8 is another implementation flowchart of the flattened conductor fabrication means.

### DETAILED DESCRIPTION OF THE PREFERRED EMBODIMENTS

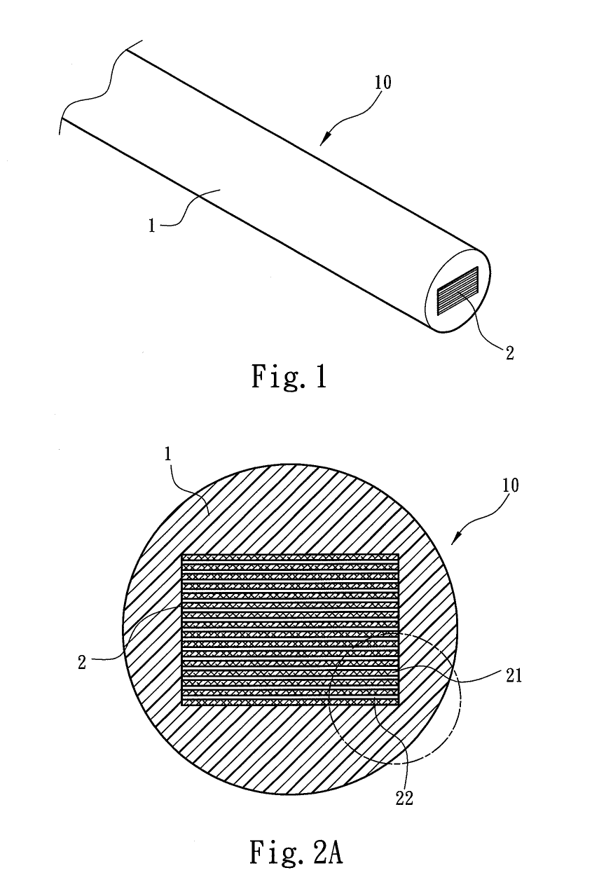

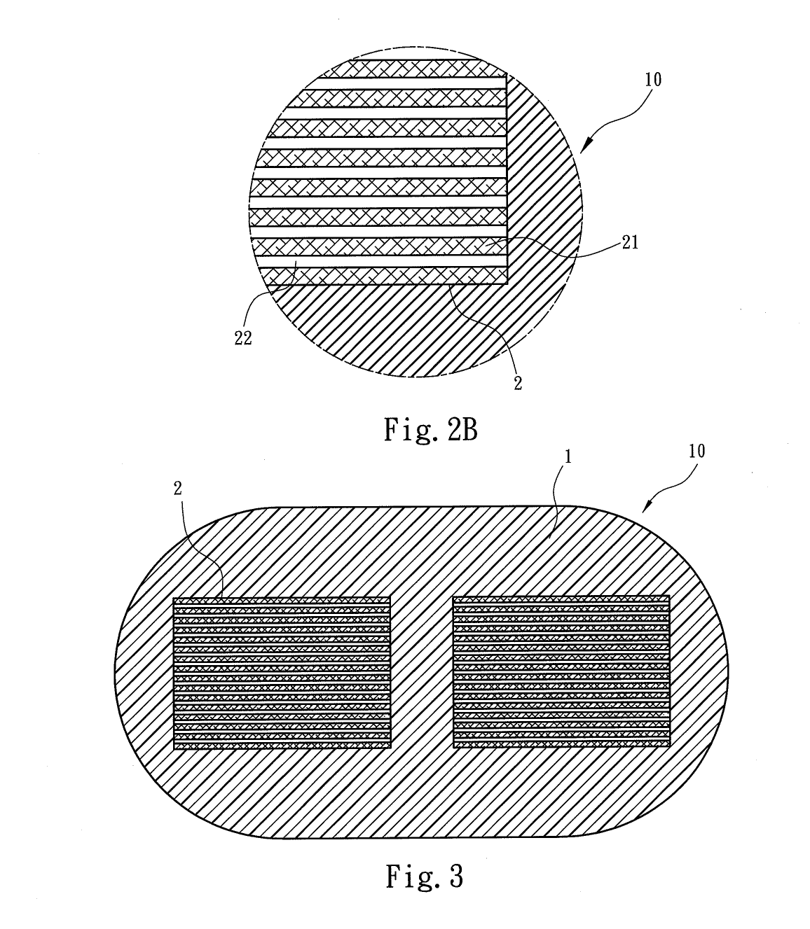

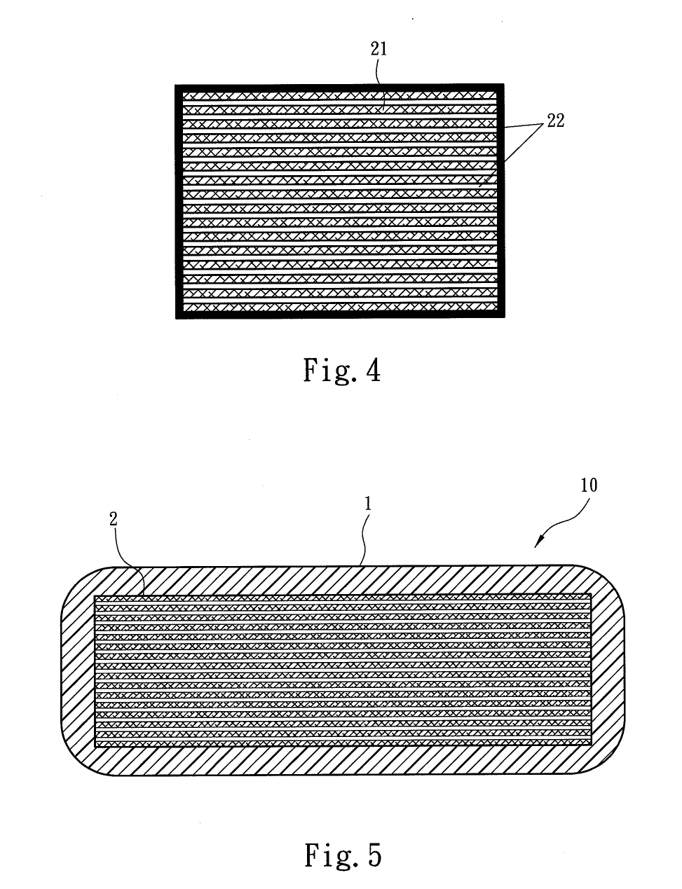

The present invention aims to provide a conducting wire structure and a method of manufacturing a core in the conducting wire. Referring to FIGS. 1 and 2A, a conducting wire 10 according to the present invention has a core 2 located inside. The core 2 contains a plurality of flattened conductors 21 each is formed in a flattened cross section and coated on the circumference with an insulation layer 22. The insulation layer 22 bonds the neighboring flattened conductors 21 to form the core 2. The flattened conductors 21 conduct an identical electric signal. FIG. 1 illustrates en embodiment in which the core 2 is encased by an insulation skin 1 to become a commonly used insulated conducting wire. As the core 2 is formed by stacking a plurality of flattened conductors 21, in addition to the circumference of the core 2, the spaced flattened conductors 21 in the core 2 also provide surface area to conduct electric power. Hence the portion of electric conduction in the core 2 is the sum of surface area of the flattened conductors 21. Referring to FIG. 2B, the flattened conductors 21 in the core 2 are stacked coaxially to form a flattened cross section at a thickness of the core 2. The insulation layer 22 coated between the flattened conductors 21 to bond every two neighboring flattened conductors 21 together to become the core 2 in an integrated manner, finally the core 2 is encased by the insulation skin 1 to form the conducting wire 10. In order to equip the flattened conductors 21 of the core 2 with consistent electric conductivity, they are made of the same conductive material. Based on the technique previously discussed, two cores 2 may further be encased in the insulation skin 1 of the conducting wire 10 and spaced by the insulation skin 1 (referring to FIG. 3). FIG. 3 illustrates one conducting wire 10 containing two cores 2 as an example, but it is not the limitation of the allowable number of the core 2 encased by the insulation skin 1. The core 2 also may be laid independently on a circuit or wound on electronic elements. Refer to FIG. 4 for the cross section of the core 2 that contains multiple flattened conductors 21 to conduct same electric power. The flattened conductors 21 are bonded together in the integrated manner by the insulation layer 22 coated on the circumference. Hence the core 2 can be regarded as an ordinary conducting wire wound on a transformer, inverter or choke coil or other winding racks to provide desired electromagnetic induction. Because the core 2 can provide excellent conductivity, circuit elements can also have improved electrical performance. The core 2 provided by the present invention also can be used on a flattened conducting wire 10 (referring to FIG. 5) adopted in smaller computers or 3C information products. In short, the conducting wire 10 provided by the present invention has maximum conductive area of the core 2 by stacking a plurality of flattened conductors 21, thus can improve performance in conduction of high frequency current or high frequency signals, and also enhance electric conductivity.

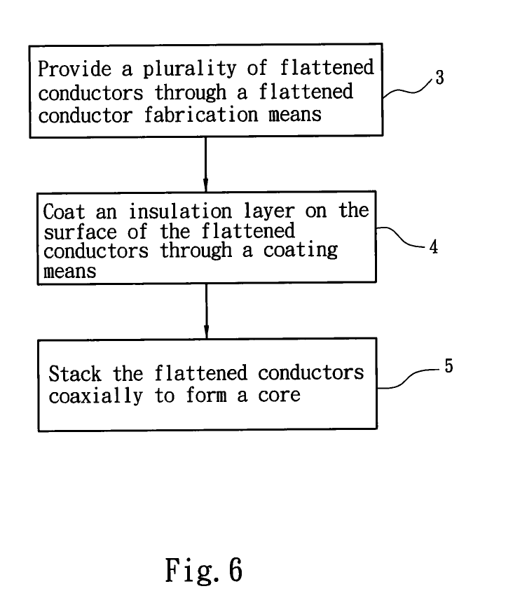

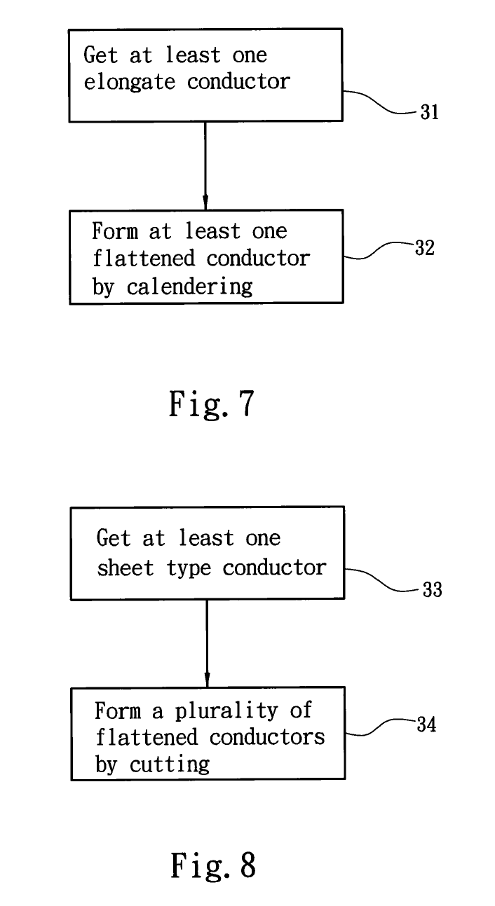

In order to facilitate production and promote wider applications of the conducting wire 10 provided by the present invention previously discussed, the present invention also provides a method to fabricate the core 2 formed by stacking a plurality of flattened conductors 21. Referring to FIG. 6, the method comprises steps as follow: step 3: providing a plurality of flattened conductors 21 through a flattened conductor fabrication means; step 4: coating an insulation layer 22 on the surface of the flattened conductors 21 through a coating means; step 5: stacking the flattened conductors 21 coaxially to form the core 2, and bonding every two flattened conductors 21 through the adhesive insulation layer 22 to form the core 2 is a desired shape. The flattened conductor fabrication means previously discussed can be divided into two implementation approaches. Refer to FIG. 7 for a first approach in which two steps 31 and 32 are included. Step 31: getting at least one elongate conductor with no limitation in cross section shape; step 32: calendering the elongate conductor to form at least one flattened conductor 21. Then step 4 can be proceeded to fabricate the core 2. Another approach includes steps 33 and 34, referring to FIG. 8. Step 33: getting a sheet type conductor with a cross section in the flattened shape; step 34: cutting the sheet type conductor to form a plurality of flattened conductors 21 at a preset dimension. Then step 4 can be proceeded to fabricate the core 2. Through the flattened conductor fabrication means previously discussed, the raw material of the flattened conductors 21 can be fabricated by calendering like the general metal conducting wire fabrication, or by cutting metal foils. The manufacturing method provided by the present invention does not increase raw material cost, and the processes of calendaring, cutting and coating the insulation layer 22 are basic fabrication operations, thus the core 2 can be made at a lower cost and marketed at a competitive price to increase adaptability and applications. As a conclusion, the present invention can maximize conductive surface area and fabricate at a faster speed and a lower cost, and provide a conducting wire with a higher conductivity. It offers a significant improvement over the conventional techniques.

While the preferred embodiments of the invention have been set forth for the purpose of disclosure, they are not the limitation of the invention. For instance, there is no limitation on the thickness of the flattened conductors 21 and insulation layer 22. The insulation layer 22 can be formed by selecting varying insulation materials of different insulation strengths according to different requirements, thus modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A core structure, comprising:
a plurality of flattened conductors each formed in a flattened cross section; and
an insulation layer coating on the circumference of the flattened conductors and bonding neighboring flattened conductors together to form a core.

2. The core structure of claim 1, wherein the flattened conductors are made of a same conductive material.

3. The core structure of claim 1, wherein the core is formed by stacking the flattened conductors coaxially.

4. The core structure of claim 1, wherein the core conducts an identical electric signal.

5. A conducting wire structure comprising at least one core and an insulation skin encasing outer circumference of the core to form a conducting wire, wherein:
the core is formed by stacking a plurality of flattened conductors to conduct an identical electric signal.

6. The conducting wire structure of claim 5, wherein the flattened conductors are formed in a flattened cross section and stacked to form the thickness of the core.

7. The conducting wire structure of claim 5, wherein the flattened conductors are interposed by an insulation layer which bonds two neighboring flattened conductors.

8. The conducting wire structure of claim 5, wherein the flattened conductors are made of a same conductive material.

9. The conducting wire structure of claim 5, wherein the core is formed by stacking the flattened conductors coaxially.

10. The conducting wire structure of claim 5, wherein the conducting wire includes a plurality of cores formed by stacking a plurality of flattened conductors, two cores being spaced by the insulation skin.

11. A method for manufacturing a core of a conducting wire, comprising the steps of:
providing a plurality of flattened conductors each formed in a flattened cross section through a flattened conductor fabrication means;
coating an insulation layer on the surface of the flattened conductors through a coating means; and
stacking the flattened conductors coaxially to form the core.

12. The method of claim 11, wherein the flattened conductor fabrication means is to calendar at least one conductor to form the flattened conductors with the flattened cross section.

13. The method of claim 11, wherein the flattened conductor fabrication means is to get a sheet type conductor which has a flattened cross section and cutting the sheet type conductor to become the flattened conductors.

14. The method of claim 11, wherein the insulation layer is adhesive to bond the flattened conductors.

15. The method of claim 11, wherein the flattened conductors are made of a same conductive material.
